(19) United States
(12) Patent Application Publication
(10) Pub. No.: US 2025/0299452 A1
(43) Pub. Date: Sep. 25, 2025

(54) INTERACTIVE RE-SCAN SOLUTION BASED ON CHANGE DETECTION

(71) Applicant: InterDigital CE Patent Holdings, SAS, Paris (FR)

(72) Inventors: Matthieu Fradet, Chanteloup (FR); Olivier Roupin, Rennes (FR); Caroline Baillard, Saint Sulpice la Foret (FR)

(21) Appl. No.: 18/872,862

(22) PCT Filed: Jun. 6, 2023
(86) PCT No.: PCT/EP2023/065054

§ 371 Date: Dec. 9, 2024

(30) Foreign Application Priority Data
Jun. 9, 2022 (EP) 22305838.9

(51) Int. Cl. G06T 19/20

(52) U.S. Cl. CPC G06T 19/20; G06T 2219/2021

(57) ABSTRACT

Methods, device are provided to re-scan a 3D scene in which changes occurred. A 3D model of the 3D scene is obtained, and a scanning device is localized in the 3D scene. The scanning device starts to scan the 3D scene. Differences between the scanned parts of the 3D scene and the 3D model are detected and highlighted on a view displayed to a user. Options are provided to the user to modify the 3D model by adding new detected objects, removing detecting absent objects or ignoring the changes. The 3D model is updated accordingly and a new part of the 3D scene is scanned.

### 1. TECHNICAL FIELD

The present principles generally relate to the domain of three-dimensional scanning and 3D reconstruction. In particular, the present principles relate to detection of changes in re-scan or scan extension processes. The present document is also understood in the context of the formatting and the playing of extended reality applications when rendered on end-user devices such as mobile devices or Head-Mounted Displays (HMD).

### 2. BACKGROUND

The present section is intended to introduce the reader to various aspects of art, which may be related to various aspects of the present principles that are described and/or claimed below. This discussion is believed to be helpful in providing the reader with background information to facilitate a better understanding of the various aspects of the present principles. Accordingly, it should be understood that these statements are to be read in this light, and not as admissions of prior art.

3D scanning and 3D reconstruction are processes of capturing the 3D shape and appearance of real surfaces through collecting and analyzing data corresponding to real-world objects or environments. Reconstructed 3D models of objects can be used in different situations. For example, 3D models can be used for object/place detection/recognition and for triggering an action like displaying of additional information (Augmented Reality). 3D models can be used for object pose estimation/camera re-localization and are required to render real-virtual interactions (occlusions, bouncing, shadows . . . ). in Mixed Reality experiences, 3D model can be used as new 3D content to populate 3D assets database or to be displayed in commercial catalogues or extended reality (XR) applications.

Application domains are as broad as e-shopping, gaming, education, cultural heritage, training, industrial maintenance, virtual tourism where 3D scanning becomes accessible to consumers thanks to mobile-based scanning solutions while previous solutions were still reserved to professionals (complex multi-camera setup, fixed camera array, tedious user interactions, time consuming, cost . . . ). Scanning remains a crucial task and should be performed carefully. Even when considering 3D scenes containing non-self-moving objects only, many of these objects are moveable and such scenes rarely remain static as soon as a human being visit the real-world environment. For example, doors are opened, chairs are moved. Precise 3D model reconstructions often require updates (in case that a part of the environment has changed, a subsequent scan focusing on this part is required) and/or extension steps (in case that a part of the environment has not been scanned during the initial scan).

Scanning solutions provide point clouds that are used to create meshes of the scanned surfaces. A mesh is composed of faces (usually triangles or quadrilaterals). Some mobile 3D scanning solutions feature an extension mode: a 3D mesh model scanned beforehand is reloaded, and it can be completed after re-localization. The completion process behaves as follows: some new faces are added, and some existing faces are kept even if they correspond to removed objects. Users cannot decide or control the insertion or the discarding of new faces nor the conservation or the removal of existing faces. There is a lack of a solution in which changes are highlighted and so may be labelled or annotated in order to bring added value to the reconstructed 3D model.

### 3. SUMMARY

The following presents a simplified summary of the present principles to provide a basic understanding of some aspects of the present principles. This summary is not an extensive overview of the present principles. It is not intended to identify key or critical elements of the present principles. The following summary merely presents some aspects of the present principles in a simplified form as a prelude to the more detailed description provided below.

The present principles relate to a method comprising:
obtaining a 3D model of a 3D scene;
localizing a scanning device in the 3D scene;
scanning the 3D scene with the scanning device and detecting differences between the 3D model and the scanned 3D scene;
highlighting the differences in a view of the 3D scene; and
modifying the 3D model according to a change detection mode.

In an embodiment, a user can modify the change detection mode between a scanning of two parts of the 3D scene. The change detection mode belongs to a set of modes comprising: keep detected removals and add detected insertions; remove detected removals and ignore detected insertions; keep detected removals and ignore detected insertions; and remove detected removals/add detected insertions. In an embodiment, a manual mode allows to display change detection options to a user for keeping or ignoring detected removals and/or detected insertions and wherein the 3D model is modified upon a choice of an option by the user. In another embodiment, the method comprises maintaining a database of removed objects of the 3D scene and, when a new object is detected, searching for an occurrence of the detected object in the database. The scanning device may capture RGB(D) frames of a part of the 3D scene. Then, the differences are detected by comparing the RGB(D) frames with the corresponding part of the 3D model. The highlighting of the differences may be displayed on live video frames or on a static RGB(D) frame in which the differences are fully visible.

The present principles also relate to a device comprising a scanning device and a display device and configured for implementing the methods above.

### 4. BRIEF DESCRIPTION OF DRAWINGS

The present disclosure will be better understood, and other specific features and advantages will emerge upon reading the following description, the description making reference to the annexed drawings wherein:

FIG. 1 illustrates a method for interactively scanning a 3D scene based on change detection according to the present principles;

FIG. 2 shows a reference view and two augmented views after re-scan according to the present principles;

FIG. 3 shows an example architecture of a device which may be configured to implement a method described in relation with FIG. 1, according to the present principles.

### 5. DETAILED DESCRIPTION OF EMBODIMENTS

The present principles will be described more fully hereinafter with reference to the accompanying figures, in which examples of the present principles are shown. The present principles may, however, be embodied in many alternate forms and should not be construed as limited to the examples set forth herein. Accordingly, while the present principles are susceptible to various modifications and alternative forms, specific examples thereof are shown by way of examples in the drawings and will herein be described in detail. It should be understood, however, that there is no intent to limit the present principles to the particular forms disclosed, but on the contrary, the disclosure is to cover all modifications, equivalents, and alternatives falling within the spirit and scope of the present principles as defined by the claims.

The terminology used herein is for the purpose of describing particular examples only and is not intended to be limiting of the present principles. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components but do not preclude the presence or addition of one or more other features, integers, steps, operations, elements, components, and/or groups thereof.

Moreover, when an element is referred to as being “responsive” or “connected” to another element, it can be directly responsive or connected to the other element, or intervening elements may be present. In contrast, when an element is referred to as being “directly responsive” or “directly connected” to other element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the present principles.

Although some of the diagrams include arrows on communication paths to show a primary direction of communication, it is to be understood that communication may occur in the opposite direction to the depicted arrows.

Some examples are described with regard to block diagrams and operational flowcharts in which each block represents a circuit element, module, or portion of code which comprises one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

Reference herein to “in accordance with an example” or “in an example” means that a particular feature, structure, or characteristic described in connection with the example can be included in at least one implementation of the present principles. The appearances of the phrase in accordance with an example” or “in an example” in various places in the specification are not necessarily all referring to the same example, nor are separate or alternative examples necessarily mutually exclusive of other examples.

Reference numerals appearing in the claims are by way of illustration only and shall have no limiting effect on the scope of the claims. While not explicitly described, the present examples and variants may be employed in any combination or sub-combination.

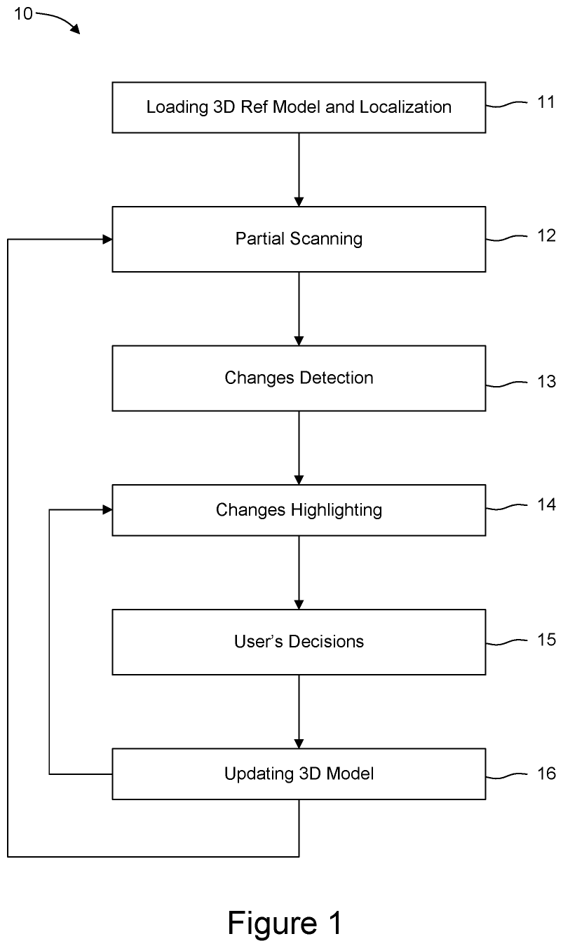

FIG. 1 illustrates a method 10 for interactively scanning a 3D scene based on change detection according to the present principles. The method applies to a system comprising a scanning device and a display device providing a view of the scanned 3D scene to a user.

At a step 11, the system is initiated. A reference 3D model of the 3D scene is obtained in association with localization data. The scanning device is localized relative to the coordinate system of the 3D scene according to the localization data and the reference 3D model. For example, the reference 3D model is a 3D mesh provided as an “obj” file (textured or not), obtained by an existing mobile 3D scanning solution using LiDAR technology or by a photogrammetry pipeline. Associated localization data are usually derived from the keyframes used for the reconstruction, their poses are relative to the coordinate system in which the 3D mesh is registered and to the set of feature points extracted from these keyframes and their descriptors. They usually come in a format that directly depends on the chosen reconstruction solution. The localization of the scanning device consists in estimating the pose (location plus orientation) of the device relative to an environment scanned beforehand (“model space”). It can be for example computed by extracting 2D feature points in a keyframe and matching them to 3D feature points computed during reconstruction. When running an augmented reality (AR) application, the device is able to determine its own pose relative to the “world” of the current AR session (also called “world space”). This means that the transform between the 3D model space and the world space is obtained by combining both devices' poses. The reference 3D mesh can also be the first 3D model constructed, on the fly, by the present scanning device implementing the present scanning method. In such a case, localization is straightforward.

At step 12 of the method according to the present principles, a partial scanning of the 3D scene is performed by the scanning device. For example, RGB(D) frames (i.e. color plus depth images) are captured by the (mobile) scanning device and sent to a change detection module with their poses relatively to the model space. Such live poses may be directly computed from the live poses of the camera in the world space and the transform between the model space and the world space without proceeding to localization for each new frame. In case the change detection module is not implemented on the scanning device but on a server (for instance, on a PC or in the cloud), RGB(D) frames and poses may be sent to the server in HTTP requests for example.

At step 13, local geometry changes between the reference 3D model and the partially scanned model are searched and detected. For example, the live RGB(D) frames are compared with the reference 3D mesh using a hybrid approach based on projections and reprojection. The changes (insertions and removals) are first detected in 2D at the level of pixels of the RGB(D) frames, then in the 3D model space as 3D regions (groups of 3D points or parametric 3D shapes like ellipsoids or parallelepipedons for instance) in the 3D model space by triangulation.

At step 14, 3D regions corresponding to detected changes are projected in 2D in the user view and displayed to the user (for instance, contours, specific color or a semi-transparency level for removal and for insertion). 3D regions corresponding to detected changes are rendered in the user view and displayed in AR to the user. For example, ellipsoids, or contours of the projected ellipsoids, or 3D faces included in the ellipsoids, or wireframe are rendered with a specific color and a semi-transparency level for removal and in a different given color for insertion. Animation effects can be applied by playing on semi-transparency level to illustrate appearance of inserted faces and disappearance of removed faces.

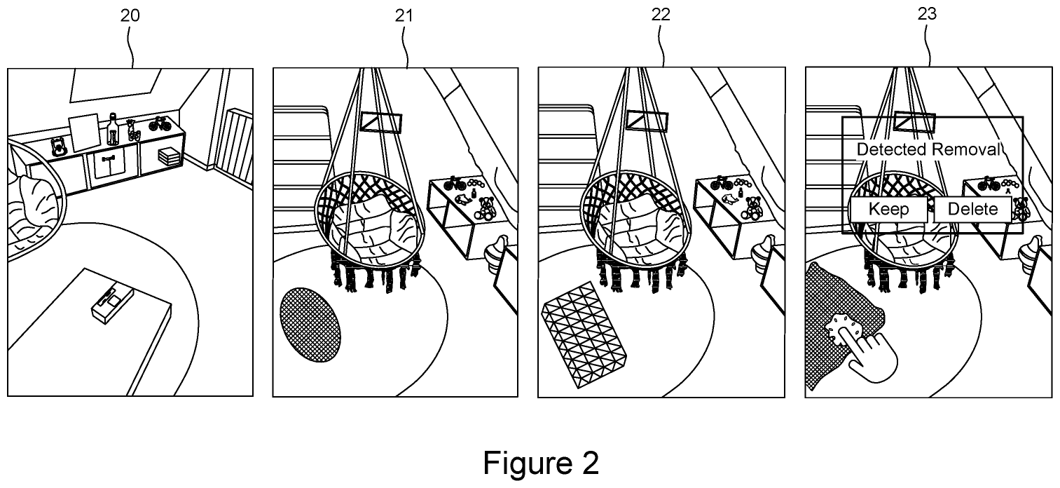

FIG. 2 shows an example reference view 20 and two augmented views 21 and 22 after a re-scan. In this example, the reference view 20 has been established at a reference point of view and the localization data refers to this point of view. When a new (or the same) scanning device is introduced in the scene at a new pose, pictures 21 and 22 can be captured. In the scene represented by picture 20, there is a box on the floor. In the same scene, but captured later, from a different point of view in the same 3D space, the box has vanished. Technically speaking, the faces of the 3D mesh representing the 3D scene, have moved or have been cancelled. In the example of FIG. 2, the absence of the box is highlighted in the user's view as an ellipsoid (in picture 21) or as a mesh (in picture 22). Similar highlighted representations are possible for object (i.e. mesh) additions. Many other representations are possible as long as they are explicit for the user. For example, removing may be highlighted in red when additions may be highlighted in green. When selecting such a highlighted region of his view, the user can confirm or infirm the default action (removing or addition) as showed in picture 23. Many ways are possible to indicate in AR to the user that the system has detected a removal. For instance, 3D virtual elements may be rendered in real time on the top of the real environment observed from the current user viewpoint. In picture 21, a semi-transparent ellipsoid. In picture 22, a wireframe of the faces of the reference 3D mesh is included in the change region. In another example, not represented, part of the reference 3D textured mesh included in the change region is displayed in semi-transparency and with a reddish re-colorization.

At step 15 of FIG. 1, the user takes and inputs a decision according to the highlighted regions displayed on his view. Each detected 3D change region is made interactive by associating a collider. When the users select a region, they are asked how the Graphical User Interface (GUI) has to behave. For example, for the detected removals, two buttons may appear to keep the 3D faces included in the 3D region or to delete them from the reference mesh (as in picture 23). Once a button is clicked, both buttons may vanish, and the required action performed. For newly inserted objects, the user can similarly be asked whether the object has to be ignored or added to the reference mesh. In a variant, the whole reference mesh might be searched in order to find a potential occurrence of the object located at another position (meaning that the object has changed place). The output of the search might be a set of possible 3D regions in the reference mesh that might correspond to the “new” object, which can be presented to the user for selection and/or validation. The search might be limited to the set of removed objects. If available among the data accompanying the reference mesh, former RGB keyframes that possibly comprise the same object before it has changed place are displayed to the user for selection and/or validation. In another variant, if the object was moved, the motion between previous and current positions might be determined by automatic estimation of its 3D transform (e.g., based on 3D feature point matching) and presented to the user for validation (ex: rotation along a specific axis, translation, etc).

Cases of moved objects may also concern situations like a drawer that has been opened or closed (revealing or hiding the content inside), a door that has been opened or closed (revealing or hiding the room behind), an object that has been overturned . . . In case of voluntary scanning, such complex situations are particularly interesting in order to obtain a more complete knowledge of the objects. The user can easily indicate that the “removed” front side and the “new” back side of a door do belong to a same object (similarly for the front and the inner of a drawer) whereas automatic matching may fail. In a variant, the maintenance of a database of new and removed objects may be implemented. When a removal or an insertion is detected, the corresponding 3D change region might be stored (3D shape, views, . . . ) along with (at least) its last known position, in order to maintain a database of “known” objects. Whenever a new object is detected, the database can be searched in order to find a potential occurrence of the object in the database.

At step 16, the 3D model is updated according to the detected and highlighted changes and according to the user's decisions. For detected removals, if the user decides to keep the 3D faces included in the detected 3D region, no update is performed. If the users decide to delete the 3D faces, every face with all its vertices in the 3D region is removed from the mesh. For detected insertions, if the user decides to ignore the 3D faces included in the detected 3D region, no update is performed. If the user decides to add the 3D faces, every face with all its vertices in the 3D region is added to the mesh. If the object was detected as “moved”, then the previous version of the mesh can be used for update in addition to scanning. If the object is totally new, then the user can be notified that the object should be scanned with accurate precision. Once the update is performed, the region highlight is switched off and another region can be selected. Once a decision has been taken for each region, new live RGB(D) frames can be considered and sent to the change detection.

In another embodiment, a history of all detected changes and user decisions is maintained in metadata related to relevant faces and embedded in the 3D mesh or in the scene description and exportable in an output format. Considering the .obj file format, the polygonal geometry of the mesh may be split up into different objects, for example using the “g” groupName or “o” objectName grouping keywords. Thus, for a set of faces detected as an insertion, and whatever the user decision to add it or ignore it, a new group is created and added to the file. Similarly for a removal, and whatever the user decision to keep it or remove it, the corresponding faces are cut from the main mesh and pasted into a new group. groupName and objectName descriptions or additional keywords may contain information about detection type (insertion or removal), user decision (to keep, to remove, to add, to ignore), username or time.

In this embodiment, object detection is applied to the RGB(D) frames, for example using deep neural networks, so that naming the object classes subject to the detected insertions is made possible. Similarly, if the reference mesh has been processed jointly with semantic segmentation, semantic metadata are available and naming the object classes subject to the detected removals is made possible. For detected insertion of object of a class A, the whole reference mesh might be searched in order to find a potential occurrence of an object of same class A located at another position (meaning that the object has changed place). The output of the search might be a set of possible 3D regions in the reference mesh that might correspond to the “new” object, which can be presented to the user for selection or validation. The search might be limited to the set of removed objects of class A. Semantics may also be used to help estimating the 3D motion of objects by reducing the number of degrees of freedom: typically, a door rotates around a vertical axis, a drawer translates horizontally on the axis orthogonal to the plane of the front. When displaying the detected regions to the user, names can be displayed as text or pronounced by voice synthesis (e.g., “A new chair has been inserted. Do you want to add it to the model?”). Object names can also be saved in the history and exported in output files (for example using the “o insertedChair” grouping keyword that may be included in an .obj file). If in addition, a scene graph representation is available and contains information about spatial relationships between objects contained in the scene, detections can be further characterized, for instance, to solve ambiguities in case of several instances of the same object. “A new chair has been inserted between the table and the fireplace”.

In another embodiment, required user interactions or validations are limited. In this embodiment, the following predefined automatic modes are presented to the user through the GUI, for example as radio buttons:
1. ALL/MAX: keep detected removals/add detected insertions=>minimize the empty (i.e., non-occupied) space=>build/update the STABLE/SECURED empty space and corresponding (adjacent) surfaces
2. MIN: remove detected removals/ignore detected insertions=>maximize the empty space=>build/update the STABLE/UNMOVABLE environment as the set of stable surfaces
3. OLD: keep detected removals/ignore detected insertions=>build/update the set of old surfaces
4. NEW: remove detected removals/add detected insertions=>build/update the set of new surfaces

These options are mutually exclusive. The user has to select exactly one choice (“manual” being a fifth mode selected by default). In other words, clicking a non-selected radio button will deselect whatever other button was previously selected in the list. As long as a mode other than “manual” is selected, the system does not require specific user decision to process each change region: mesh updates corresponding to selected mode are automatically applied for all detected removals and insertions until the mode is unselected.

In another embodiment, the changes are displayed on top of a static image corresponding to the last RGB frame that has conducted to the detected change rather than on top of the live video stream. It allows the user to focus on the subsequent decisions without having to keep its device camera pointed to a specific 3D location, and without having to exit the program as the live video stream is displayed again as soon as the last user decision is taken.

In another embodiment, to avoid displaying the changes as soon as they are detected, the displaying is postponed while keeping detecting other possible changes and maintaining a list of the changes. Displaying of the changes to the user is started only after a given amount of time (e.g., after N minutes of scanning) or on demand. In this embodiment, since the user may have moved between the detection time and the display time, the detected changes can be alternatively displayed on top of stored RGB frames that best show the changes rather than on top of live video stream.

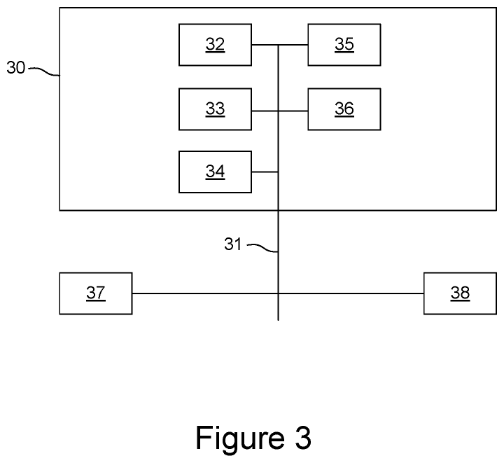

FIG. 3 shows an example architecture of a device 30 which may be configured to implement a method described in relation with FIG. 1. A device according to the architecture of FIG. 3 is linked with other devices via their bus 31 and/or via I/O interface 36.

Device 30 comprises following elements that are linked together by a data and address bus 31:
a microprocessor 32 (or CPU), which is, for example, a DSP (or Digital Signal Processor);
a ROM (or Read Only Memory) 33;
a RAM (or Random Access Memory) 34;
a storage interface 35;
an I/O interface 36 for reception of data to transmit, from an application; and
a power supply (not represented in FIG. 3), e.g. a battery.

In accordance with an example, the power supply is external to the device. In each of mentioned memory, the word «register» used in the specification may correspond to area of small capacity (some bits) or to very large area (e.g. a whole program or large amount of received or decoded data). The ROM 33 comprises at least a program and parameters. The ROM 33 may store algorithms and instructions to perform techniques in accordance with present principles. When switched on, the CPU 32 uploads the program in the RAM and executes the corresponding instructions.

The RAM 34 comprises, in a register, the program executed by the CPU 32 and uploaded after switch-on of the device 30, input data in a register, intermediate data in different states of the method in a register, and other variables used for the execution of the method in a register.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Device 30 is linked, for example via bus 31 to a set of sensors 37 and to a set of rendering devices 38. Sensors 37 may be, for example, cameras, microphones, temperature sensors, Inertial Measurement Units, GPS, hygrometry sensors, IR or UV light sensors or wind sensors. Rendering devices 38 may be, for example, displays, speakers, vibrators, heat, fan, etc.

In accordance with examples, the device 30 is configured to implement a method according to the present principles described in relation to FIG. 1, and belongs to a set comprising:
a mobile device;
a communication device;
a game device;
a tablet (or tablet computer);
a laptop;
a still picture camera;
a video camera.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, Smartphones, tablets, computers, mobile phones, portable/personal digital assistants (“PDAs”), and other devices that facilitate communication of information between end-users.

Implementations of the various processes and features described herein may be embodied in a variety of different equipment or applications, particularly, for example, equipment or applications associated with data encoding, data decoding, view generation, texture processing, and other processing of images and related texture information and/or depth information. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette (“CD”), an optical disc (such as, for example, a DVD, often referred to as a digital versatile disc or a digital video disc), a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described embodiment, or to carry as data the actual syntax-values written by a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

Amendments to and listing of the claims:

1. A method comprising:
obtaining a three-dimensional (3D) model of a 3D scene and localization data;
localizing a scanning device in the 3D scene according to the localization data and the 3D model;
scanning the 3D scene with the scanning device and detecting differences between the 3D model and the scanned 3D scene;
highlighting the differences in a view of the 3D scene; and
modifying the 3D model according to a change detection mode.

2. The method of claim 1, wherein a user is able to modify the change detection mode between a scanning of two parts of the 3D scene, and wherein the change detection mode belongs to a set of modes comprising:
keep detected removals and add detected insertions;
remove detected removals and ignore detected insertions;
keep detected removals and ignore detected insertions; and
remove detected removals and add detected insertions.

3. The method of claim 2, wherein the set of change detection modes comprises a manual mode in which one or more change detection options are displayed to a user, wherein the one or more change detection options comprise one or more of keeping detected removals, ignoring detected removals, keeping detected insertions, and ignoring detected insertions, and wherein the 3D model is modified upon a choice of at least one of the one or more change detection options by the user.

4. The method of claim 1, comprising maintaining a database of removed objects of the 3D scene and, when a new object is detected, searching for an occurrence of the new object in the database.

5. The method of claim 1, wherein the scanning device captures RGB(D) frames of a part of the 3D scene, the differences are detected by comparing the RGB(D) frames with a corresponding part of the 3D model.

6. The method of claim 5, wherein the highlighting of the differences is displayed on a static RGB(D) frame in which the differences are fully visible.

7. The method of claim 1, wherein the 3D model is a 3D mesh, and wherein modifying the 3D model comprises modifying faces of the 3D mesh.

8. The method of claim 1, wherein the highlighting of the differences is performed over a period of time after the detection of the differences.

9. A device comprising a scanning device and a display device and configured for:
obtaining a three-dimensional (3D) model of a 3D scene and localization data;
localizing a scanning device in the 3D scene according to the localization data and the 3D model;
scanning the 3D scene with the scanning device and detecting differences between the 3D model and the scanned 3D scene;
highlighting the differences in a view of the 3D scene displayed on the display device; and
modifying the 3D model according to a change detection mode.

10. The device of claim 9, wherein a user is able to modify the change detection mode between a scanning of two parts of the 3D scene, and wherein the change detection mode belongs to a set of modes comprising:
keep detected removals and add detected insertions;
remove detected removals and ignore detected insertions;
keep detected removals and ignore detected insertions; and
remove detected removals/add detected insertions.

11. The device of claim 10, wherein the set of change detection modes comprises a manual mode in which one or more change detection options are displayed to a user, wherein the one or more change detection options comprise one or more of keeping detected removals, ignoring detected removals, keeping detected insertions, and ignoring detected insertions, and wherein the 3D model is modified upon a choice of an at least one of the one or more change detection options by the user.

12. The device of claim 9, wherein the device is further configured for maintaining a database of removed objects of the 3D scene and, when a new object is detected, searching for an occurrence of the new object in the database.

13. The device of claim 9, wherein the scanning device captures RGB(D) frames of a part of the 3D scene, the differences are detected by comparing the RGB(D) frames with a corresponding part of the 3D model.

14. The device of claim 13, wherein the highlighting of the differences is displayed on a static RGB(D) frame in which the differences are fully visible.

15. The device of claim 9, wherein the 3D model is a 3D mesh and wherein modifying the 3D model is modifying faces of the 3D mesh.

16. The device of claim 9, wherein the highlighting of the differences is performed over a period of time after the detection of the differences.
